(19) United States
(12) Patent Application Publication
(10) Pub. No.: US 2021/0240575 A1
(43) Pub. Date: Aug. 5, 2021

(54) DYNAMIC BACKUP MANAGEMENT

(71) Applicant: Wells Fargo Bank, N.A., San Francisco, CA (US)

(72) Inventor: Edward Mulheren, Charlotte, NC (US)

(21) Appl. No.: 14/595,454

(22) Filed: Jan. 13, 2015

(51) Int. Cl. G06F 11/14

(52) U.S. Cl. CPC G06F 11/1464; G06F 2201/80

(57) ABSTRACT

An example electronic computing device includes a processing unit and a system memory. The system memory includes instructions that, when executed by the processing unit, cause the electronic computing device to identify a backup job to execute. The backup job is identified by determining that dependency conditions have been met for the backup job. Additionally, a backup device is identified for the backup job. The backup device is identified by selecting a lowest cost backup device that is available and has an estimated probability of success for the backup job that is a greater than a minimum success probability threshold. The backup job is executed using the identified backup device.

### BACKGROUND

Computer systems are often used to store large amounts of data. The data may be inputted by one or more users of the computer system. Additionally, the data may be generated by the computer system as well. For example, the computer system may generate data by performing various operations on data entered by users. Additionally, the computer system may store data that corresponds to various user interactions with the computer system. The data may also be received over a communication network from another computer.

Computer systems may store this data for various purposes. For example, the data may be used in providing services to consumers or to maintain a record of services that have been provided. The data may also be recorded to comply with various laws or regulations. The data may need to be stored for a specific time period, such as many years. For example, some regulations may require that particular types of data be stored for a time period of between one and thirty years.

To ensure that the data is stored for the desired time period, backup systems are commonly used. A backup system stores one or more backup copies of the data. By storing the data on a backup system the data can be maintained even if the computer system that was originally storing the data fails. The backup system may be located in a local or remote location. Additionally, the backup system may use various technologies for backing up data such as network attached storage (NAS), storage area network (SAN), cloud-based storage, locally attached storage, and enterprise backup appliances.

### SUMMARY

Embodiments of the disclosure are directed to an electronic computing device.

In a first aspect, an electronic computing device comprises: a processing unit; and system memory, the system memory including instructions which, when executed by the processing unit, cause the electronic computing device to: identify a backup job to execute, wherein the backup job is identified by determining that dependency conditions have been met for the backup job; identify a backup device from a pool of candidate backup devices for the backup job, wherein the backup device is identified by selecting a lowest cost backup device from the pool of candidate backup devices that is available and has an estimated probability of success for the backup job that is greater than a minimum success probability threshold; execute the backup job using the identified backup device.

In another aspect, a method of dynamically managing backups includes the steps of: identifying, using a dynamic backup management server, a plurality of candidate backup jobs; identifying a backup job to execute from the plurality of candidate backup jobs, wherein the backup job is identified by determining that dependency conditions have been met for the backup job; identifying a backup device for the backup job; allocating an initial quantity of channels for the backup job; dynamically allocating additional channels for the backup job, wherein the additional channels are allocated one at a time until a channel allocation fails; and executing the backup job using the identified backup device and the allocated channels.

In yet another aspect, an electronic computing device comprises: a processing unit; and system memory, the system memory including instructions which, when executed by the processing unit, cause the electronic computing device to: identify a plurality of candidate backup jobs; identify a backup job to execute from the plurality of candidate backup jobs, wherein the backup job is identified by determining that dependency conditions have been met for the backup job; identify a backup device for the backup job, wherein the backup device is identified from a pool of candidate backup devices by selecting a lowest cost backup device that is available and has an estimated probability of success for the backup job that is a greater than a minimum success probability threshold, wherein a cost is associated with each of the backup devices in the pool of candidate backup devices. allocate an initial quantity of channels for the backup job; dynamically allocate additional channels for the backup job, wherein the additional channels are allocated one at a time until a channel allocation fails; execute the backup job using the identified backup device; monitor the backup job; and upon detecting an anomaly during execution of the backup job: identify a second backup device for the backup job; and execute the backup job using the second backup device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports dynamic backup management.

FIG. 2 shows example modules of the dynamic backup management engine of FIG. 1.

FIG. 3 is a flow chart for an example method of dynamically managing backup jobs that is used by some embodiments of the dynamic backup management engine of FIG. 1

FIG. 4 shows a data structure of an embodiment of a backup job record that is used by some embodiments of the dynamic backup management engine.

FIG. 5 is a flow chart for an example method of dynamically allocating a backup device for a backup job that is used by some embodiments of the resource allocation module of FIG. 2.

FIG. 6 is a flow chart illustrating an example method of dynamically allocating channels for a backup job that is used by some embodiments of the resource allocation module of FIG. 2.

FIG. 7 shows example physical components of the dynamic backup management server computer of FIG. 1.

### DETAILED DESCRIPTION

The present disclosure is directed to systems and methods for dynamic backup management. In some examples, an enterprise may include a plurality of application computing devices that generate, use, and store various types of data. The application computing devices may store the data in local data stores or in remote data stores (e.g., data stores located on different computing devices).

In addition to the application computing devices, the enterprise may also include a dynamic backup management server and one or more data backup devices. The data backup devices are used to store backup copies of the data in the data stores. The data backup devices may include one or more backup technologies. Each of the backup devices may be associated with different costs and benefits. Additionally, the various backup devices may have different limitations in terms of, for example, storage capacities and data transfer rates. The data backup devices may be connected directly to the dynamic backup management server or one or more of the application computing devices. Alternatively, the data backup devices may be connected to the application computing devices via a network.

The organization may have various policies governing when some or all of the data stores are to be backed-up. These policies may be dictated by various regulations that are applicable to the industry in which the organization operates. Additionally, the policies may be based on practices the organization has chosen to implement for various reasons such as to minimize the probability of data loss. Adhering to these policies is often difficult, however, because each of the application computing devices and backup devices as well as the network is all subject to operational interruptions or even permanent failures.

Accordingly, some embodiments of the systems and methods for dynamic backup management operate to dynamically manage performance of the back-up operations in accordance with the policies of the organization and subject to the limitations of the networks and backup devices. Additionally, the dynamic backup management server may operate to allocate the appropriate backup devices and other resources for use in completing the requested backup jobs.

In the examples described herein, the dynamic backup management system uses computing devices that have been programmed to perform special, complex functions. These specially-programmed devices function to improve the performance and function of the computing devices to optimize backup device utilization, increase the speed in which backups are performed, and improve the probability of success of the backups that are performed. Additionally, some embodiments minimize the use of external network resources. For example, as described in more detail below, the processes performed by the computing devices allow the organization to comply with the determined backup policies.

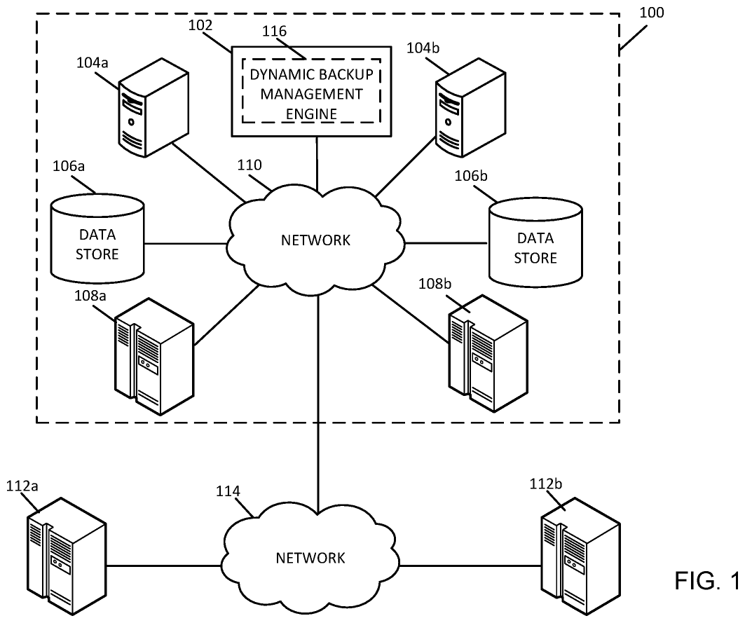

FIG. 1 is a schematic block diagram of an example system 100 for dynamic backup management. In this example, the system 100 includes a dynamic backup management server 102, application computing devices 104a and 104b (collectively referred to as application computing devices 104), data stores 106a and 106b (collectively referred to as data stores 106), backup devices 108a and 108b (collectively referred to as backup devices 108), and a network 110. Also shown are external backup devices 112a and 112b (collectively referred to as external backup devices 112) and a network 114. The dynamic backup management server 102 includes a dynamic backup management engine 116. More or fewer application computing devices, data stores, and backup devices are used in some embodiments.

The dynamic backup management server 102 operates to manage dynamic backups in the system 100. The server 102 comprises one or more computing devices and may include a database backup and recovery management software application, such as the ORACLE® Recovery Manager (RMAN) software distributed by ORACLE® Corporation. In at least some embodiments, the server 102 includes a Web server or a file server. In some embodiments, the server 102 comprises a plurality of computing devices that are located in one or more physical locations. For example, the server 102 can be a single server or a bank of servers.

In some embodiments, the dynamic backup management server 102 establishes one or more channel for use in backing up a data store to a particular one of the backup devices 108 or external backup devices 112. In some embodiments, a channel represents a separate process on the dynamic backup management server 102 that operates to copy all or part of a data store.

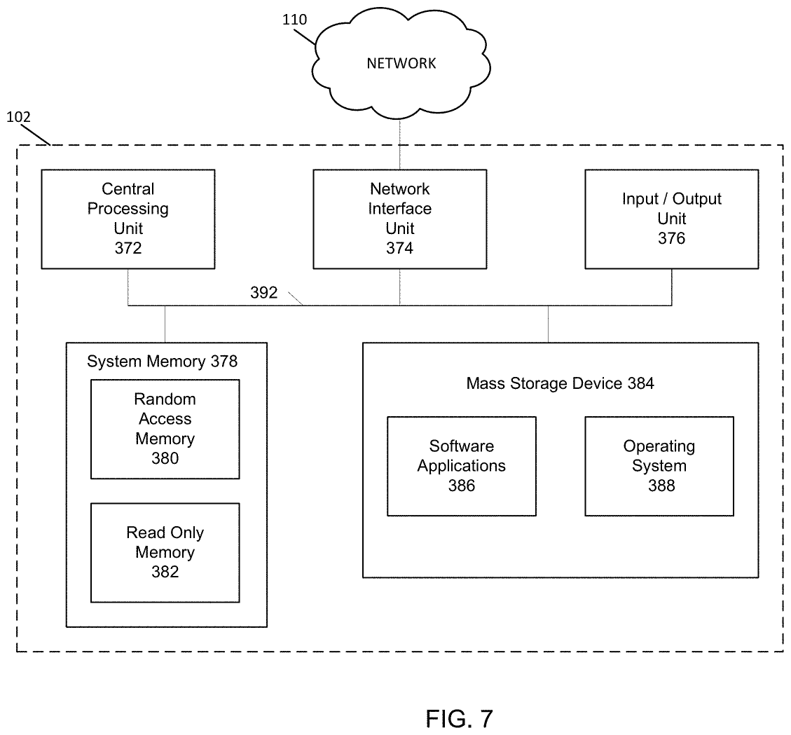

Multiple channels can be established to perform a backup in parallel, with each of the channels being used to copy a portion of the data store in parallel. In theory, the more channels that are used the more quickly the backup can be completed. However, there are practical limitations to the number of channels that can be used. For example, each channel uses system memory (e.g., system memory 378, illustrated in FIG. 7) on the dynamic backup management server 102 as a buffer for the data being copied from a data store.

Accordingly, the number of channels available for performing a backup may be limited by the system memory capacity on the dynamic backup management server 102, which may be shared by multiple backup jobs that are running at the same time. Additionally, there may be a diminishing return to allocating additional channels to a single backup job because, for example, a network or backup device may not be able to adequately keep up with the data transmitted from the multiple channels.

The application computing devices 104 comprise one or more computing devices that are configured to execute various applications, which may do one or more of receiving, processing, and generating data. Additionally, the applications performed by the application computing devices 104 may store at least some of that data in the data stores 106. The application computing devices 104 may be server computers, client computers, laptop computers, desktop computers, mobile devices, or any similar electronic computing devices.

The application computing devices 104 can be configured to execute any type of application from any industry. Example applications performed by some embodiments of the application computing devices 104 include accounts payable applications, payroll applications, general ledger applications, customer service applications, customer resource management applications, transaction processing applications, enterprise resource management applications, and other types of applications.

The data stores 106 are devices configured to store data, such as data related to the applications performed by the application computing devices 104. Examples of the data stores 106 include a hard disk drive, a collection of hard disk drives, digital memory (such as random access memory), a redundant array of independent disks (RAID), optical or solid state storage devices, or other data storage devices. The data can be distributed across multiple local or remote data storage devices.

In some embodiments, the data stores 106 store data in an organized manner, such as in a hierarchical or relational database structure, or in lists and other data structures such as tables. The data stores 106 may also include a file system. Each of the data stores 106 can be stored on a single data storage device or distributed across two or more data storage devices that are located in one or more physical locations. The data stores 106 can each be single databases or multiple databases. In at least some embodiments, the data stores 106 are located on the server 102 or on the application computing devices 104.

The backup devices 108 are devices configured to store data. In at least some embodiments, the backup devices 108 store one or more full or partial backup copies of the data in the data stores 106. Examples of the backup devices 108 include network attached storage (NAS), storage area networks (SANs), private cloud-based storage, locally attached storage, and enterprise backup appliances. Yet other embodiments are possible as well.

The network 110 communicates digital data between the server 102, the application computing devices 104, the data stores 106, and the backup devices 108. The network 110 may communicate data between additional devices as well. The network 110 can be a local area network or a wide area network, such as the Internet. One or more of the server 102, the application computing devices 104, the data stores 106, and the backup devices 108 can be in the same geographic location or can be in different locations.

The external backup devices 112 are devices configured to store data. The external backup devices 112 may be similar to the backup devices 108 except that the external backup devices 112 are external to the system 100. For example, the external backup devices 112 may comprise cloud-based storage that is available through the Internet. Other examples of the external backup devices 112 include network attached storage (NAS), storage area networks (SANs), locally attached storage, and enterprise backup appliances. Yet other embodiments are possible as well.

The network 114 communicates digital data between one or more computing devices, such as the computing devices comprising the system 100 and the external backup devices 112. The network 114 can be a local area network or a wide area network, such as the Internet. In at least some embodiments, the network 110 and the network 114 are a single network, such as the Internet or the same local area network.

The example dynamic backup management engine 116 includes software modules that implement dynamic management of backups, including scheduling backups, managing backup dependencies, prioritizing backups, identifying and allocating backup resources, executing backups, monitoring backups, and analyzing historical backup data. The example dynamic backup management engine 116 is described in greater detail elsewhere herein.

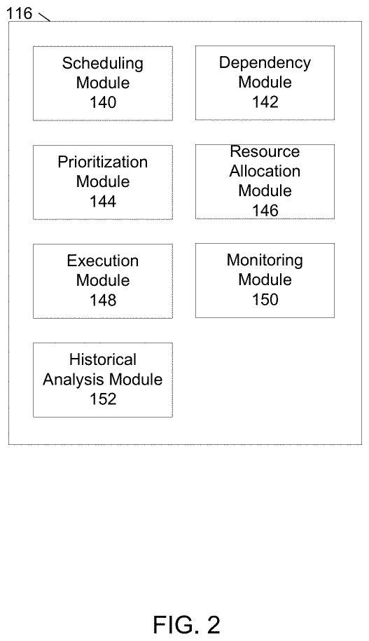

FIG. 2 shows example modules for the dynamic backup management engine 116. In this example, the dynamic backup management engine 116 includes a scheduling module 140, a dependency module 142, a prioritization module 144, a resource allocation module 146, an execution module 148, a monitoring module 150, and a historical analysis module 152.

The scheduling module 140 operates to maintain a schedule of backup jobs. The backup jobs in the schedule may be input into the schedule by a system operator, such as through a user interface provided by the scheduling module 140. Alternatively or additionally, the backup jobs in the scheduling module 140 may be identified and added to the schedule based on historical backup job data by, for example, the historical analysis module 152.

The dependency module 142 operates to track and evaluate dependency conditions between backup jobs. Additionally, the dependency module 142 may track and evaluate dependencies between backup jobs and application or data store events. For example, a backup job related a general ledger application may be dependent on the completion of an accounts payable application. Prior to execution of a backup job, the dependency module 142 may evaluate the job to determine whether all of its dependencies have been satisfied. The dependencies may be input by a system operator, such as through a user interface provided by the dependency module 142. Alternatively or additionally, the dependencies may be identified and added based on historical backup job data by, for example, the historical analysis module 152.

The prioritization module 144 prioritizes pending backup jobs based on various criteria such as organizational policies, which may be based on laws or regulations. The prioritization module 144 may apply additional considerations in prioritizing backup jobs as well. For example, the prioritization module 144 may prioritize backup jobs based on when the related applications need to be back online, prioritizing the backup jobs for data stores used by applications that need to be back online earlier ahead of the backup jobs for other applications. However, the prioritization module 144 is not limited to backup jobs that require the application to be offline.

The resource allocation module 146 operates to allocate resources such as backup devices and channels to backup jobs. In some embodiments, the resource allocation module 146 dynamically modifies the resources assigned to a backup job during execution. For example, the resource allocation module 146 may continue to allocate additional channels to a backup job throughout execution so long as more channels are available and performance increases.

The resource allocation module 146 may allocate resources to a backup job based on organizational policies, such as a requirement (or preference) that the backup data be stored offsite or that the backup job be completed by a particular time. The resource allocation module 146 may also allocate resources to facilitate the completion of a backup job or group of backup jobs in the shortest amount of time possible.

As another factor, the resource allocation module 146 may allocate resources in a manner that increases the probability that the backup job will complete successfully based on, for example, historical backup data analyzed by the historical analysis module 152. Alternatively or additionally, the resource allocation module 146 may allocate resources to minimize the cost of completing the backup job. For example, using one of the external backup devices 112 may have a greater cost than using, for example, one of the backup devices 108.

The execution module 148 operates to execute a backup job. For example, the execution module 148 may execute the backup job using resources allocated by the resource allocation module 146. In some embodiments, the execution module 148 performs the backup directly (e.g., the execution module 148 copies data from one of the data stores 106 to one the backup devices 108 or one of the external backup devices 112). In other embodiments, the execution module 148 instructs another process or system to perform the backup job.

The monitoring module 150 operates to monitor a backup job as the backup job executes. In at least some embodiments, the monitoring module 150 also operates to identify completion and failure of the backup job. The monitoring module 150 may also determine various performance-related parameters of an executing backup job, such as a data transfer rate. In at least some embodiments, the monitoring module 150 also operates to cause the execution module 148 to re-execute a backup job in the event that failure or unacceptable performance is detected.

The historical analysis module 152 operates to analyze historical data about backup jobs. For example, the historical analysis module may analyze historical backup jobs to determine a success rate of backup jobs when a particular resource is used such as one of the backup devices 108 or external backup devices 112. The historical analysis module may also analyze historical backup job data to determine an average data transfer rate using a particular resource. Additionally, the historical analysis module may also analyze historical backup job data to identify patterns in backup jobs such as regularly scheduled jobs or potential dependencies.

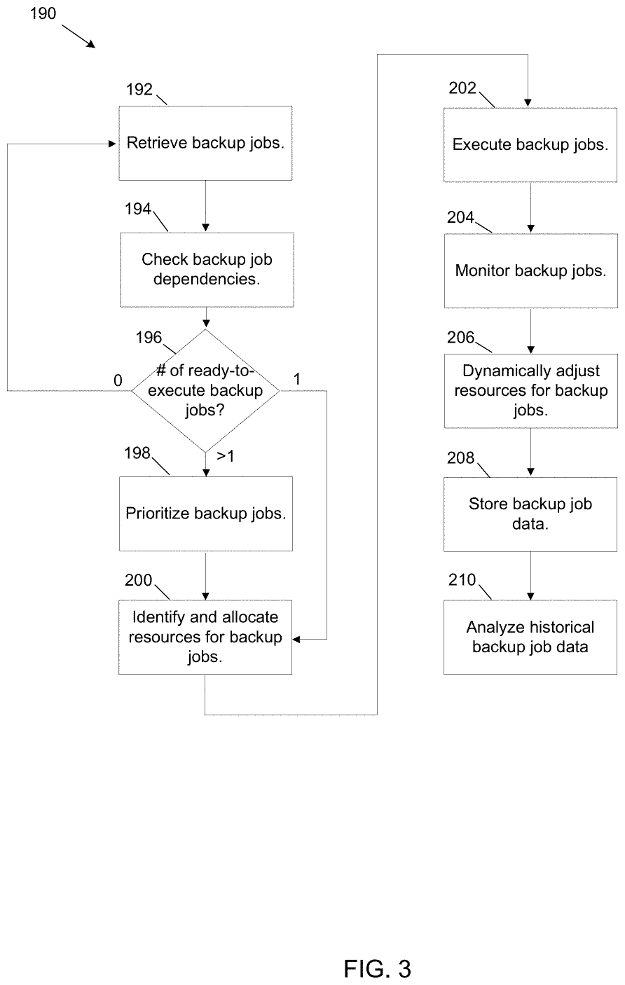

FIG. 3 is a flow chart illustrating an example method 190 of dynamically managing backup jobs using the system 100. In some embodiments, the method 190 is performed by the dynamic backup management engine 116 in conjunction with one or more processing devices (such as the central processing unit 372, shown in FIG. 7). In this example, the method 190 includes operations 192, 194, 196, 198, 200, 202, 204, 206, 208, and 210, which are discussed below in numeric order but, in at least some embodiments, are performed in a different order.

At operation 192, the dynamic backup management engine 116 retrieves backup jobs that need to be performed. The backup jobs may be scheduled by the scheduling module 140. Additionally, the backup jobs may be requested dynamically by an operator or an application. In at least some embodiments, the backup jobs are retrieved by querying a database that stores records associated with pending backup jobs. In addition to identifying the data store (or portion thereof) that is to be backed up, the records may include additional information as well.

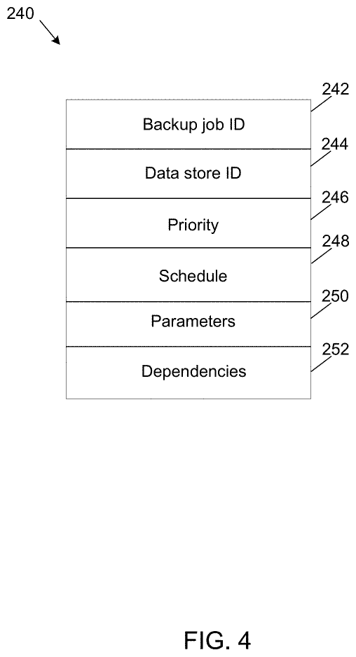

For example, FIG. 4 shows a data structure of an embodiment of a backup job record 240 that is used by some embodiments of the dynamic backup management engine 116. The backup job record 240 includes a backup job ID field 242, a data store ID field 244, a priority field 246, a schedule field 248, a parameters field 250, and a dependencies field 252. Other embodiments may include different, fewer, or additional fields.

The backup job ID field 242 stores an identifier of the backup job. In some embodiments, the backup job ID field 242 stores a unique identifier of the backup job (i.e., no other backup job records have the same identifier). The backup job ID field 242 may be a primary key in a database table and may be used in other records to refer to a particular backup job record.

The data store ID field 244 stores an identifier of one of the data stores 106 that is to be backed up. In some embodiments, the data store ID field 244 also specifies a path or Internet Protocol (IP) address of the data store. Additionally, the data store ID field 244 (or another field) may specify whether the whole data store or a particular portion (e.g., certain tables or files, recent changes, etc.) of the data store is to be backed up.

The priority field 246 stores an assigned priority value for the backup job. For example, backup jobs may be assigned a numeric priority value from 1-3, where jobs with a priority value of 1 are highest priority and those with a value of 3 are lowest priority. In some embodiments, a backup job is assigned a priority value of 1 to indicate that the backup job is being performed to comply with industry regulations. Other embodiments use other priority values, however.

The schedule field 248 stores data that relates to the scheduling of the backup job. For example, the schedule field 248 may store a desired start time for the backup job and a desired completion time. The schedule field 248 may also store additional data about the schedule for the backup job, such as whether the start and end times are preferences or requirements. For example, it may be required that the backup job for a data store used by a transaction processing application be complete before the following business day starts, while it may be merely a preference that the backup job starts at 6:00 p.m. In some embodiments, the schedule field 248 comprises multiple fields (e.g., multiple fields in a relational database table or XML file).

The parameters field 250 stores parameters that are used by or are related to the backup job. The parameters may be required parameters (such as a service level requirement for the backup) or default initial parameters. Example parameters include the number of channels to use for the backup job, the buffer size, the desired backup media type, and desired backup location. For example, it may be preferable to perform a backup job to an offsite backup device so that a localized failure (e.g., a natural disaster, power outage, etc.) does not harm both the data store and the backup device. In some embodiments, the parameters field 250 comprises multiple fields (e.g., multiple fields in a relational database table or XML file).

The dependencies field 252 stores information about events or conditions that the backup job is dependent upon. In some embodiments, a backup job will not be started until all of the identified dependencies have been met. For example, in some embodiments, the dependencies field 252 identifies other backup jobs (such as by a backup job ID) that must complete before the backup job may commence. Alternatively, the dependency field may identify various other events that the backup job is dependent on such as the completion of an application process running on one of the application computing devices 104. Other embodiments are possible as well.

The backup job record 240 is just an example. Other embodiments may include different or additional data. Additionally, while in some embodiments the fields of the backup job record 240 are stored as a single record, in other embodiments these fields may be stored across multiple records (e.g., multiple tables or multiple XML files). Many other embodiments are possible as well.

Referring back to FIG. 3 now, at operation 194, the dependencies of the retrieved backup jobs are checked. The dependencies may be retrieved from the dependencies field 252 of the backup job record 240. If the dependencies have all been met, the backup job is ready for execution. If not, the backup job will not yet be executed.

At operation 196, the number of ready-to-execute backup jobs is determined. If there are no backup jobs that are currently ready to execute, the method returns to operation 192 where backup jobs are again retrieved. If, instead, there is more than one backup job that is ready to execute, the method proceeds to operation 198 where the backup jobs are prioritized. If there is only one backup job that is ready to execute, the method proceeds to operation 200, where resources are identified for executing the backup job.

At operation 198, the ready-to-execute backup jobs are prioritized. The backup jobs may be prioritized in whole or in part using information from the backup job record 240. For example, the backup jobs may be prioritized based on the value of the priority field 246. In addition to the priority field 246, the jobs may also be prioritized based on information in the schedule field 248. For example, a high priority job that does not need to be completed for several hours may be treated equally with a medium priority job that must be completed within an hour. Other embodiments are possible as well.

At operation 200, resources are identified and allocated for the backup jobs. In some embodiments, the resources that are identified and allocated to a backup job include a backup device and one or more channels. In some embodiments, the number of channels allocated to a particular backup job is based, at least in part, upon the block size of the particular data store that is to be backed up by the backup job. The resources may be allocated based in part on the data in the schedule field 248 and the parameters field 250 of the backup job record 240.

In some embodiments, the resources are identified to optimize or balance one or more of the cost of performing the backup job, the probability the backup job will complete successfully, and the time required to complete the backup job. Some embodiments optimize or balance different criteria as well.

Further, in some embodiments, resources are identified and allocated in light of external factors such as upcoming scheduled jobs and the availability of various resources. For example, if a high priority job is not yet ready to run but is scheduled to run soon, some embodiments will allocate fewer resources to the current backup jobs so as to preserve resources for the upcoming high priority job. Additionally, in some embodiments, the resources are allocated based on resource availability. For example, a backup job may be allocated to an alternate backup device if the first choice backup device (e.g., based on balancing probability of success and cost) is currently unavailable due to being in heavy use performing other backup jobs or due to being offline for maintenance, etc.

At operation 202, the backup jobs are executed. For example, in some embodiments, the backup jobs are executed using the “backup” command in the ORACLE® Recovery Manager (RMAN) tool from ORACLE® Corporation. However, in other embodiments, other tools and techniques are used to execute the backup jobs. Additionally, the backup jobs may be executed using various parameters to, for example, specify a number of channels to use.

Additionally, in some embodiments, the backup jobs are executed using compression technology. Further, in some embodiments, compression technology is used with some backup devices but not others. Various compression technologies may be used in various embodiments. Performing compression on the data in a data store may increase the computation required for execution of the backup process. Conversely, performing compression on the data may decrease the amount of time that is needed to transfer the data to the backup device. An additional benefit of compressing the data is that the compressed data requires less storage space on the backup device. Accordingly, the cost savings associated with compressing the data may be greater for certain types of backup devices that have higher storage costs. In at least some embodiments, the cost savings of compressing the data is balanced against the time required to perform compression of the data.

At operation 204, the backup jobs are monitored. The backup jobs may be monitored for errors or failures. Additionally, the backup jobs may be monitored to identify performance anomalies. For example, if a backup job is progressing more slowly (e.g., based on a detected data transfer rate) than desired or than would be expected based on analysis of historical backup job data, remedial actions may be taken. Examples of remedial actions include redirecting the backup to a different backup device, sending an alert (e.g., via e-mail or Short Message Service (SMS)) to an operator, or dynamically adjusting the resources for the backup jobs.

At operation 206, resources for the backup jobs are dynamically adjusted as necessary. In some embodiments, the resources for the backup jobs are adjusted throughout execution of the job to respond to various events. For example, if backup performance is below expectations, additional channels (or other resources) may be allocated to a particular backup job. Alternatively or additionally, a different one of the backup devices 108 or external backup devices 112 may be allocated to the backup job. Further, in some embodiments, other backup jobs may be slowed or interrupted to free more resources for completion of a high priority backup job.

At operation 208, various data about the backup job and its execution is stored. For example, some embodiments store data corresponding to whether the backup jobs were completed successfully, which backup devices were used by each of the backup jobs, how much data was backed up, the parameters used for each of the backup jobs (e.g., number of channels used, whether compression was used, etc.). However, other embodiments store additional or different data about the backup jobs.

At operation 210, historical backup job data is analyzed. The historical backup job data may be analyzed to determine the probability of success for each of the backup devices 108 and external backup devices 112. In some embodiments, the historical backup job data is also analyzed to determine the typical performance of one or all of the backup devices 108 and external backup devices 112. The results of analyzing the historical backup job data may be stored in a database where it can be accessed and used in the future by the dynamic backup management engine 116.

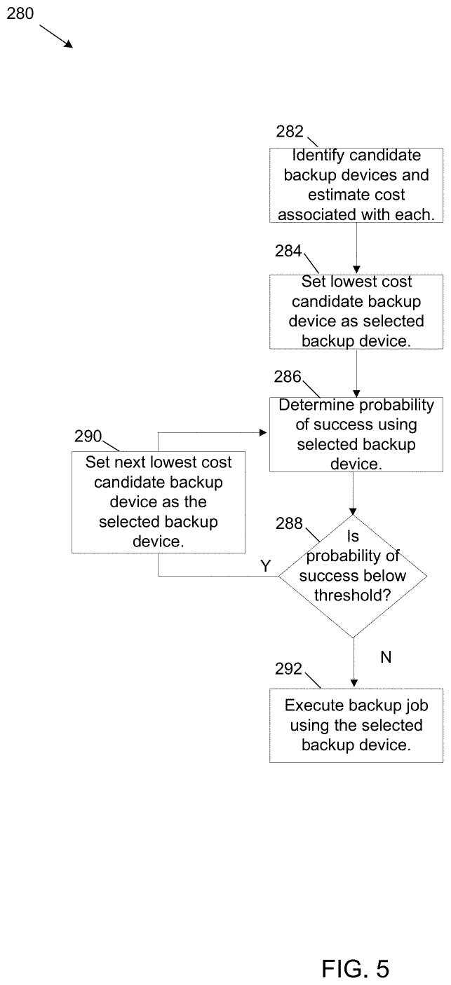

FIG. 5 is a flow chart illustrating an example method 280 of dynamically allocating a backup device for a backup job using the system 100. In some embodiments, the method 280 is performed by the resource allocation module 146 in conjunction with one or more processing devices (such as the central processing unit 372, shown in FIG. 7). In this example, the method 280 includes operations 282, 284, 286, 288, 290, and 292, which are discussed below in numeric order but, in at least some embodiments, are performed in a different order.

At operation 282, candidate backup devices are identified and the costs of performing the backup jobs using each of the candidate devices are estimated. The candidate backup devices may be identified from the backup devices 108 and external backup devices 112. The candidate backup devices may be identified based on availability as well as the backup job parameters (such as from the parameters stored in the parameters field 250 in backup job record 240, shown in FIG. 4). The costs of the backup jobs may be estimated based on known parameters of each of the backup devices 108 and external backup devices 112.

At operation 284, the lowest cost candidate backup device is identified as the selected candidate backup device. At operation 286, the probability that the backup job will succeed using the selected backup device. In some embodiments, the probability of success is determined by querying a database table containing estimated probabilities of success calculated by the historical analysis module 152. The estimated probabilities of success may be calculated by dividing the number of backup jobs that have succeeded on the selected backup device by the total number of backup jobs attempted on the selected backup device. Other embodiments are possible as well.

At operation 288, the estimated probability of success is compared to a threshold value. In some embodiments, the threshold value is 70%. However, other embodiments use threshold values from 50-99%. If the estimated probability of success is below the threshold value, the method continues to operation 290, where the next lowest cost candidate backup device is set as the selected backup device. If, however, the estimated probability of success equals or exceeds the threshold, the method continues to operation 292, where the backup job is executed using the selected backup device.

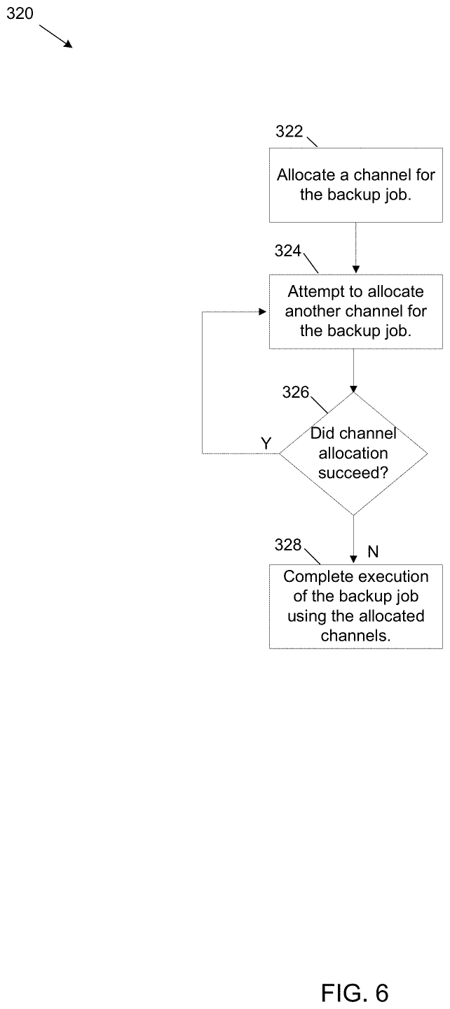

FIG. 6 is a flow chart illustrating an example method 320 of dynamically allocating channels for a backup job using the system 100. In some embodiments, the method 320 is performed by the resource allocation module 146 in conjunction with one or more processing devices (such as the central processing unit 372, shown in FIG. 7). In this example, the method 320 includes operations 322, 324, 326, and 328, which are discussed below in numeric order but, in at least some embodiments, are performed in a different order.

At operation 322, one or more channels are allocated for the backup job. In some embodiments, the number of channels specified in the parameters field 250 of the backup job record 240 is allocated. In some embodiments, a channel is allocated by reserving a preexisting channel for use by the backup job. In other embodiments, a channel is allocated by creating a new channel for the backup job. In some embodiments, the channel has a block size parameter that is set based on a block size associated with the data store.

At operation 324, the dynamic backup management server 102 attempts to allocate another channel for the backup job. Again, in some embodiments, a channel is allocated by reserving a preexisting channel while, in other embodiments, a channel is allocated by creating a new channel.

At operation 326, it is determined whether the channel allocation was successful. For example, if the channel allocation fails an error message or exception may be generated. In other embodiments, other methods are used to determine whether the channel allocation was successful. If the channel allocation was successful, the method returns to operation 324, where the dynamic backup management server 102 attempts to allocate another channel for the backup job. If instead the channel allocation fails, the method continues to operation 328 where the backup job is executed using the allocated channels.

As illustrated in the example of FIG. 7, the dynamic backup management server 102 includes at least one central processing unit (“CPU”) 372, a system memory 378, and a system bus 392 that couples the system memory 378 to the CPU 372. The system memory 378 includes a random access memory (“RAM”) 380 and a read-only memory (“ROM”) 382. A basic input/output system that contains the basic routines that help to transfer information between elements within the dynamic backup management server 102, such as during startup, is stored in the ROM 382. The dynamic backup management server 102 further includes a mass storage device 384. The mass storage device 384 is able to store software instructions and data.

The mass storage device 384 is connected to the CPU 372 through a mass storage controller (not shown) connected to the system bus 392. The mass storage device 384 and its associated computer-readable data storage media provide non-volatile, non-transitory storage for the dynamic backup management server 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the dynamic backup management server 102 can read data and/or instructions.

Computer-readable data storage media include volatile and non-volatile, removable and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store information and which can be accessed by the dynamic backup management server 102.

According to various embodiments of the invention, the dynamic backup management server 102 may operate in a networked environment using logical connections to remote network devices through the network 110, such as a wireless network, the Internet, or another type of network. The dynamic backup management server 102 may connect to the network 110 through a network interface unit 374 connected to the system bus 392. It should be appreciated that the network interface unit 374 may also be utilized to connect to other types of networks and remote computing systems. The dynamic backup management server 102 also includes an input/output controller 376 for receiving and processing input from a number of other devices, including a touch user interface display screen, or another type of input device. Similarly, the input/output controller 376 may provide output to a touch user interface display screen or other type of output device.

As mentioned briefly above, the mass storage device 384 and the RAM 380 of the dynamic backup management server 102 can store software instructions and data. The software instructions include an operating system 388 suitable for controlling the operation of the dynamic backup management server 102. The mass storage device 384 and/or the RAM 380 also store software instructions, that when executed by the CPU 372, cause the dynamic backup management server 102 to provide the functionality of the dynamic backup management server 102 discussed in this document. For example, the mass storage device 384 and/or the RAM 380 can store software instructions that, when executed by the CPU 372, cause the dynamic backup management server 102 to perform backup jobs in a robust and efficient manner.

Although various embodiments are described herein, those of ordinary skill in the art will understand that many modifications may be made thereto within the scope of the present disclosure. Accordingly, it is not intended that the scope of the disclosure in any way be limited by the examples provided.

1. An electronic computing device comprising:
a processing unit; and
system memory, the system memory including instructions which, when executed by the processing unit, cause the electronic computing device to:
receive a backup job to execute, wherein the backup job is identified by determining that dependency conditions have been met for the backup job;
receive a pool of candidate backup devices;
calculate a cost of performing the backup job for each backup device in the pool of candidate backup devices;
select a lowest cost backup device from the pool of candidate backup devices; and
calculate, for the lowest cost backup device, an estimated percentage of success for the backup job by:
query a database table containing historical backup job data;
determine, from the historical backup job data, a number of successfully completed backup jobs and a total number of attempted backup jobs; and
divide the number of successfully completed backup jobs by the total number of attempted backup jobs to determine an estimated percentage of success;
wherein, when the estimated percentage of success for the backup job is greater than a minimum success percentage threshold, execute the backup job using the lowest cost backup device; and
wherein, when the estimated percentage of success for the backup job is less than the minimum success percentage threshold:
receive a second-lowest cost backup device; and
execute the backup job using the second-lowest cost backup device.

2. The electronic computing device of claim 1, wherein the system memory further includes instructions which, when executed by the processing unit, cause the electronic computing device to:
monitor the backup job; and
upon detecting an anomaly during execution of the backup job:
identify a third-lowest cost backup device from the pool of candidate backup devices for the backup job; and
execute the backup job using the third-lowest cost backup device.

3. The electronic computing device of claim 2, wherein the anomaly is detected based on generation of at least one of an error message or an exception.

4. The electronic computing device of claim 2, wherein monitoring the backup job comprises determining a data transfer rate for the backup job, and the anomaly is detected based on a deviation in the data transfer rate of the backup job from an expected data transfer rate.

5. The electronic computing device of claim 4, wherein the expected data transfer rate is based on analysis of the historical backup job data.

6. The electronic computing device of claim 2, wherein the system memory further includes instructions which, when executed by the processing unit, cause the electronic computing device to, upon completion of the backup job:
store data relating to the backup job for use in performing historical analysis.

7. The electronic computing device of claim 1, wherein the minimum success percentage threshold is seventy percent.

8. (canceled)

9. The electronic computing device of claim 1, wherein the system memory further includes instructions which, when executed by the processing unit, cause the electronic computing device to:
allocate an initial quantity of channels for the backup job; and
dynamically allocate additional channels for the backup job, wherein additional channels are allocated one at a time until a channel allocation fails.

10-19. (canceled)

20. An electronic computing device comprising:
a processing unit; and
system memory, the system memory including instructions which, when executed by the processing unit, cause the electronic computing device to:
identify a plurality of candidate backup jobs;
identify a backup job to execute from the plurality of candidate backup jobs, wherein the backup job is identified by determining that dependency conditions have been met for the backup job;
receive a pool of candidate backup devices;
calculate a cost of performing the backup job for each backup device in the pool of candidate backup devices;
select a lowest cost backup device from the pool of candidate backup devices;
receive an estimated percentage of success for the backup job by:
query a database table containing historical backup job data;
determine, from the historical backup job data, a number of successfully completed backup jobs and a total number of attempted backup jobs; and
divide the number of successfully completed backup jobs by the total number of attempted backup jobs to determine an estimated percentage of success;
wherein when the estimated percentage of success for the backup job is greater than a minimum success percentage threshold, execute the backup job using the lowest cost backup device; and
wherein when the estimated percentage of success for the backup job is less than the minimum success percentage threshold, receive a second-lowest cost backup device and execute the backup job using the second-lowest cost backup device;
allocate an initial quantity of channels for the backup job;
dynamically allocate additional channels for the backup job, wherein additional channels are allocated one at a time until a channel allocation fails;
monitor the backup job; and
upon detecting an anomaly during execution of the backup job:
identify a third-lowest cost backup device for the backup job; and
execute the backup job using the third-lowest cost backup device.

21. The electronic computing device of claim 20, wherein the minimum success percentage threshold is seventy percent.
